(19) United States
(12) Patent Application Publication
(10) Pub. No.: US 2008/0246417 A1
(43) Pub. Date: Oct. 9, 2008

(54) Device, system and method for adjusting the luminous flux of a lamp

(76) Inventors: Renato Numeroli, Varese (IT); Paolo Di Lecce, Milano (IT)

Correspondence Address: NEIL STEINBERG, 2300 M STREET, N.W., Suite 800, WASHINGTON, DC, 20037, US

(21) Appl. No.: 12/080,455

(22) Filed: Apr. 3, 2008

(30) Foreign Application Priority Data
Apr. 3, 2007 (IT) TO2007A000238

(51) Int. Cl. H05B 37/02

(52) U.S. Cl. 315/297; 315/307

(57) ABSTRACT

The present invention relates to a device for adjusting the luminous flux of a lamp, which, in one embodiment, comprises a conversion unit for converting a main voltage into a supply voltage to be applied to one or more lamp or light elements. The device also comprises a microcontroller which controls the conversion unit in accordance with a luminous flux adjustment program which may be based on current date and time. The device also includes a receiver (for example, a GPS receiver) to receive a broadcast signal carrying date and time information employed by controller when executing the luminous flux adjustment program or for updating a clock/calendar module. The present invention also relates to a system incorporating such a device as well as to a related method for adjusting the luminous flux of a lamp.

### RELATED APPLICATION

This application claims priority to Italian Patent Application No. TO2007A000238, filed in the Italian Patent Office on Apr. 3, 2007.

### BACKGROUND INFORMATION

The present invention relates to a system, device and method for adjusting the luminous flux of a lamp.

It is known that energy can be saved by adjusting the luminous flux of lamps according to the surrounding environmental conditions. In large lighting systems, e.g., road lighting applications, the adjustment is often carried out by using centralized controllers, which adjust the voltage supplied to the lamps. Due to their complexity, centralized controllers are not always sufficiently cost-effective, i.e. they cannot ensure the return of the investment within a reasonable time. For example, this is the case of:
small systems, e.g. with less than 20 lamps, because a centralized luminous flux controller is too expensive;
systems using mercury or metal-halide lamps, which only provide limited savings;
mixed systems, wherein public lighting lamps and other domestic or industrial users are connected to the same power line. In this case, a centralized controller cannot be used, since a reduced voltage would also be supplied to applications which do not tolerate such voltage variations.

The alternative to a centralized controller is the use of local adjustment devices, i.e. “local” devices applied to every single lamp. Some examples of such devices are the dimmable electronic ballast or, in a more basic version, the triac dimmer. Both of these devices are interposed between the lamp and the power line, so that the lamp receives a supply voltage having an RMS value suitably determined by a control system (dimming signal).

In the case of a triac dimmer, the supply voltage is obtained through a phase cut control of the mains voltage, which is carried out by controlling the conduction or interdiction state of the triac. The dimmable electronic ballast provides a more accurate control, e.g. by operating in PWM mode.

The control of these local adjustment devices is typically carried out through a dedicated wire, thus making this solution both complex and costly due to the fact that control cables have to be installed; especially on existing systems, this is a very difficult task.

As known, the installation work can be made more simple by transmitting the command through Power Line Carrier communication between the control panel, which stores the program of the time-based luminous flux variation, and the lamp, where a suitable transceiver module is installed, which instructs the local adjustment device how much and when the lamp voltage must be reduced. This configuration, however, tends to be relatively expensive because of the complexity and number of control components. A problem of controlling local adjustment devices remotely has been addressed by using adjustment programs which are started automatically by the adjustment device without needing any external control signal. For example, some devices carry out a dimming cycle (i.e. a luminous flux adjustment cycle) that starts with a fixed delay (e.g. 4 hours) after power-on, while other devices use a midnight calculation algorithm based on the length of the previous night (suitably filtered to take into account any noise or black-outs) in order to determine when the lamp should be turned on and when the luminous flux thereof should be reduced.

Both of these systems suffer from reliability problems and cannot be fully programmed in order to change the luminous flux not only as a function of on/off time, but also depending on the day of the week and holidays, and period of the year.

In certain conventional road lighting systems, such programming is provided, for example, by the UNI10439 Standard, according to which the luminous flux must be reduced when the car traffic decreases by more than 75%. Notably, U.S. Patent Application Publication US2004/0239263 discloses using a clock/calendar unit to provide a date and time signal to the microcontroller of a dimmable electronic ballast, thus allowing the microcontroller to execute a predetermined lighting program.

### SUMMARY OF THE INVENTION

In one aspect, the present invention is directed to a luminous flux adjustment device which overcomes one, some or all of the drawbacks of prior-art devices and/or techniques.

The present invention, in one or more embodiments, may provide a luminous flux adjustment device which allows for full programming of the lighting cycle, which is efficient, and which requires minimal maintenance. The device and system of the present invention may be a local adjustment device with a receiver, preferably a GPS type receiver, which may, for example, periodically receive a broadcast date and time signal that is used when implementing or executing a luminous flux adjustment regime or program or for periodically updating a clock/calendar module.

The broadcast signal may be transmitted in a substantially continuous manner, so that there is no need to use a clock module/circuit or complex and expensive control signal carrier systems. The device according to the invention may be simpler to manufacture and may not require the installation costs to be sustained with prior-art solutions intended for carrying control signals.

Notably, in the event that the broadcast signal is not transmitted continuously, it may be advantageous to provide the device and/or system of the present invention with a clock/calendar module/circuit; this solution may still be advantageous compared with prior-art solutions, since a back-up battery may be avoided: in fact, even when long black-outs occur, the device may automatically synchronize the clock/calendar module as soon as power is restored and the broadcast signal including the date and time information is received.

### BRIEF DESCRIPTION OF THE DRAWINGS

In the course of the detailed description to follow, reference will be made to the attached drawings. These drawings illustrate different aspects of the present invention and, where appropriate, reference numerals illustrating like structures, components, materials and/or elements in different figures are labeled similarly. It is understood that various combinations of the structures, components, materials and/or elements, other than those specifically illustrated, are contemplated and are within the scope of the present invention.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, many of those permutations and combinations will not be discussed and/or illustrated separately herein.

FIG. 1 illustrates a first exemplary embodiment of an adjustment device, in conjunction with a lamp, according to at least one aspect of the present invention;

FIG. 2 illustrates a second exemplary embodiment of an adjustment device according to at least one aspect of the present invention;

FIG. 3 illustrates a third exemplary embodiment of an adjustment device according to at least one aspect of the present invention;

FIG. 4 illustrates an exemplary lighting system using an adjustment device according to at least one aspect of the present invention;

FIG. 5 illustrates a fourth exemplary embodiment of an adjustment device according to at least one aspect of the present invention;

FIG. 6 illustrates a fifth exemplary embodiment of an adjustment device according to at least one aspect of the present invention.

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed separately herein.

### DETAILED DESCRIPTION

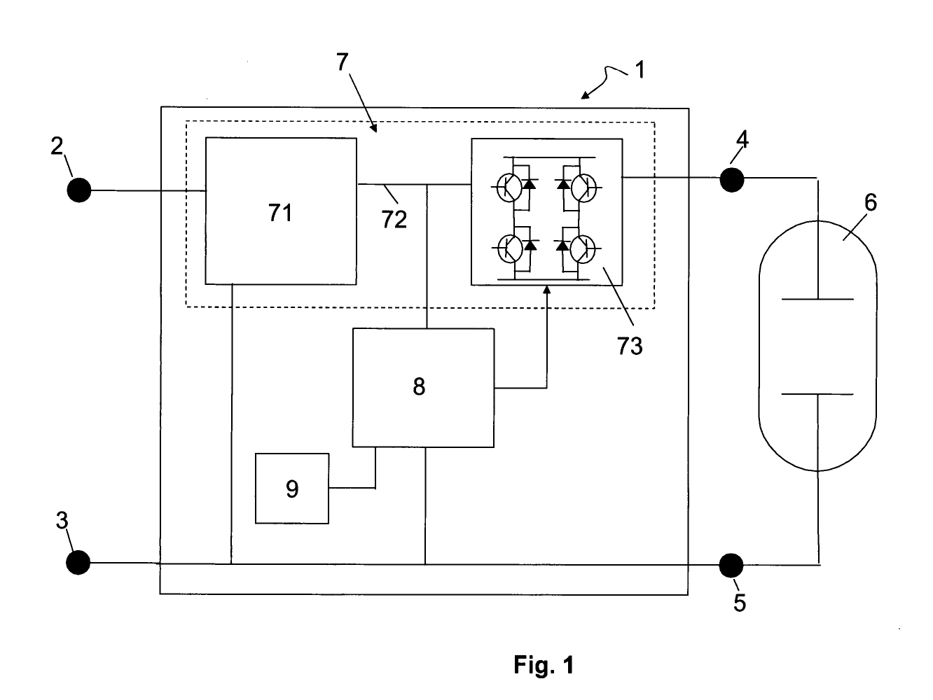

With reference to FIG. 1, in a first embodiment of an aspect of the present invention, an adjustment device 1 controllably outputs a desired and/or predetermined voltage (for example, an alternating voltage) to a lamp 6 (for example, a discharge type lamp), having characteristics (such as an RMS value) which allows the lamp to provide a desired or predetermined luminous flux.

In this embodiment, adjustment device 1 has a pair of terminals 2 and 3 to be connected to a pair of wires (for example, phase and neutral) of an electric network supplying a voltage (for example, an AC network), and a pair of output terminals 4 and 5 to be connected to a lamp 6 (which may comprise a one or more electrical light or lamp elements). By way of non-limiting example, the lamp shown in FIG. 1 is a discharge lamp, but it is clear that the present invention is also applicable to other types of lamps or lights; indeed, all lamps or lights are intended to fall within the scope of the present inventions.

The adjustment device 1 of this embodiment comprises a conversion unit 7, designated by a dashed line, which performs two operations/functions, including:
generating a desired or predetermined direct voltage to be supplied to the microcontroller 8, and
outputting (at terminals 4 and 5) an alternating voltage having an RMS value and a frequency set by the microcontroller 8.

In order to carry out the first operation/function, the conversion unit 7 comprises an AC/DC converter 71 which outputs a direct voltage to be supplied to microcontroller 8 through an output 72. In order to carry out the second operation/function, in the example of FIG. 1, conversion unit 7 further comprises an inverter 73 which receives the direct voltage generated by AC/DC converter 71 and which is controlled by microcontroller 8 in such a manner as to output a desired or predetermined alternating voltage having such an RMS value as allows to obtain the desired or predetermined luminous flux with respect to the lamp 6.

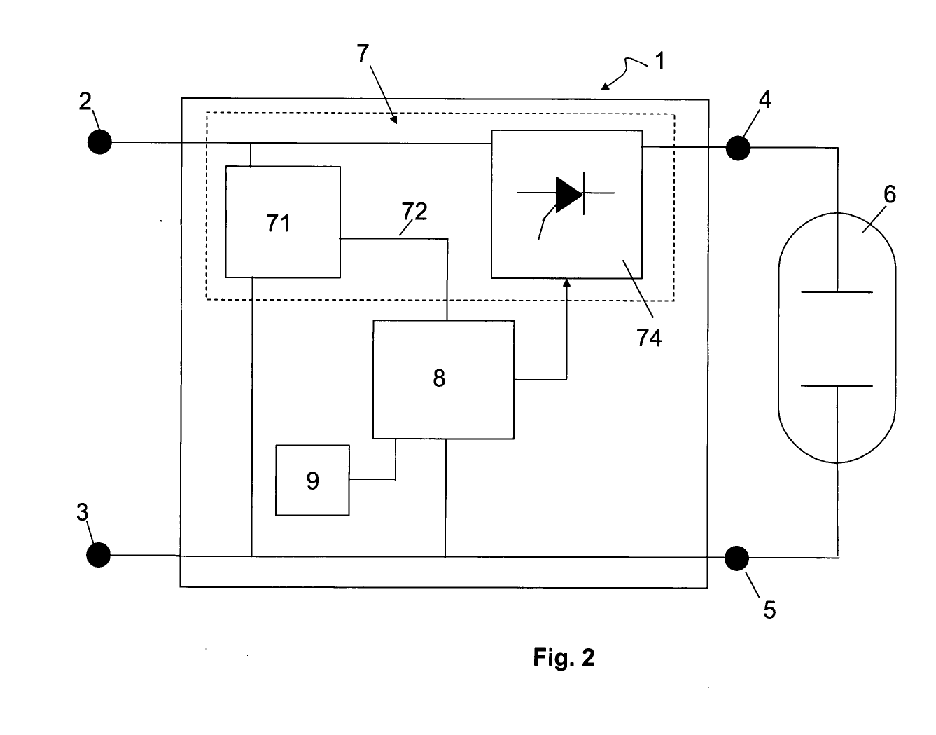

With reference to FIG. 2, in another exemplary embodiment, the output voltage of the adjustment device 1 is controlled via a phase cut control of the main voltage. In this embodiment, the adjustment device 1 includes a triac 74, which is responsively controlled by microcontroller 8, to disrupt, sever or cut the main voltage to the lamp 6.

Notably, this embodiment may be less expensive than the embodiment illustrated in FIG. 1, and may be installed outside the lighting apparatus, whereas the embodiment of FIG. 1 with an electronic ballast, should be disposed in close proximity to the lamp, thus should be installed within a housing made from thermoplastic material. Indeed, the electronic ballast must be placed very close to the lamp because discharge lamps typically require an approximate 4 kV trigger to be turned on, and cables longer than fifty centimeters cannot withstand such pulses; as a consequence, the electronic ballast is typically located within the light housing.

In both embodiments of FIGS. 1 and 2, microcontroller 8 may be programmed to execute a luminous flux adjustment which is dependent on date and time. For example, according to such an exemplary program, between Monday and Friday the lamp may be supplied with maximum voltage from 18.00 hr (that is, from system start-up) to 22.00 hr., with a first reduced voltage from 22.00 hr. to 24.00 hr., with a further reduced voltage from 00.00 hr. to 05.00 hr., and then with a maximum or full voltage again. On weekends and holidays, the microcontroller 8 (via execution of the program) may control the adjustment device 1 to supply the lamp 6 with maximum voltage from 18.00 hr. to 24.00 hr., with a reduced voltage from 00.00 hr. to 02.00 hr., with a further reduced voltage from 02.00 hr. to 05.00 hr., and then with a maximum or full voltage again.

In order to be able to execute such a program in accordance with the present invention, which is preferably stored in a non-volatile memory (for example, in memory disposed on the microcontroller), the adjustment device 1 further comprises a receiver 9 which is capable of receiving a broadcast signal (for example, a radio frequency signal). In one embodiment, receiver 9 is and/or includes GPS receiver.

Notably, the use of a GPS signal for synchronizing the clocks/calendars of the adjustment devices 1 according to certain aspects of the present invention turns out to be particularly advantageous because, for example, a GPS signal may provide significant global coverage and, in addition, may not require human intervention/agency for time control and maintenance.

Although a GPS signal may be advantageous, additional and/or different broadcast signals may be used, such as, for example, vacant or reserved frequency bands, or frequency(ies) dedicated for broadcast of such information (for example, the DCF-77 signal sent over a 77 KHz frequency from Mainflingen, near Frankfurt, which carries or provides a date and time signal within a radius of about 1500 Km).

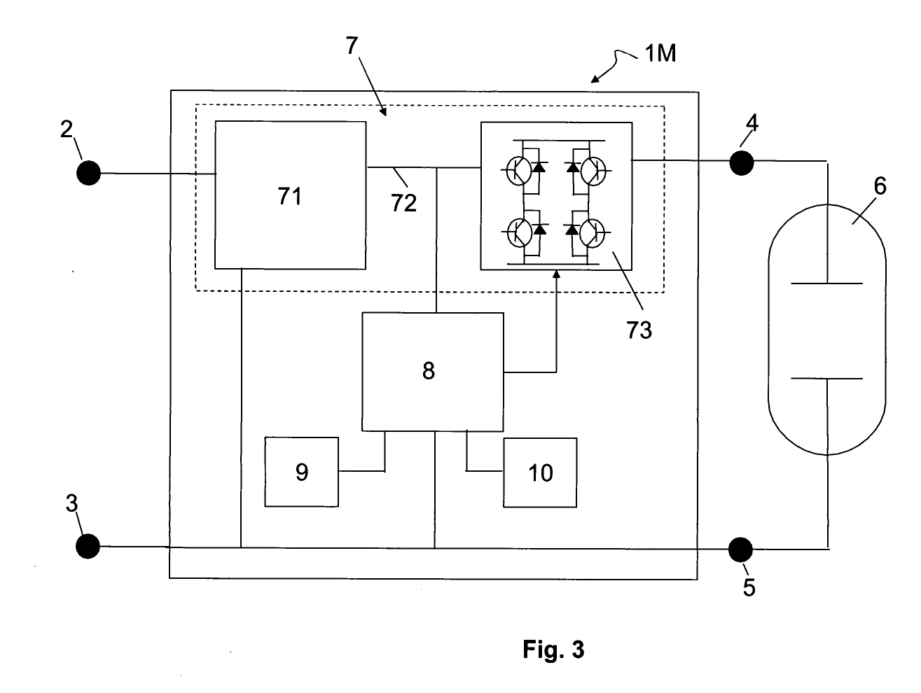

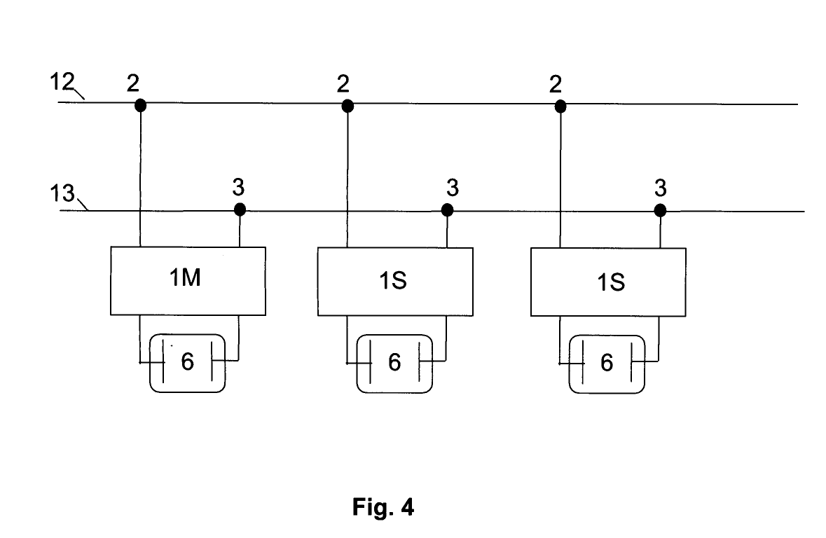

With reference to FIGS. 1 and 2, from GPS receiver 9, microcontroller 8 may obtain date and time information (for example, periodically, continuously or intermittently) which is used by microcontroller 9 during the execution of the luminous flux adjustment program. Notably, when using a GPS receiver, the microcontroller 9 should preferably be programmed by taking into account the offset relative to the Coordinated Universal Time (UTC) in the installation place. With reference to FIG. 3, in one embodiment, adjustment device 1 includes a radio frequency transceiver 10 (which may be in addition to the GPS receiver 9 (as illustrated) or in lieu thereof). Such an adjustment device may advantageously be used as a master adjustment device 1M (hence its designation as 1M in FIG. 3) in a lighting system like the one illustrated in FIG. 4, which comprises a plurality of lamps 6 to be controlled.

In the system of FIG. 4, each lamp 6 is associated with an adjustment device 1 receiving power (for example, via two wires 12 and 13 of an electric network through input terminals 2 and 3). Moreover, in the exemplary system of FIG. 4, one of adjustment devices (1M) is of the “master” type, while the adjustment devices (1S) are of the “slave” type; although two “slave” type adjustment devices are illustrated in FIG. 4, a system according to the present invention may include none, one or more than two).

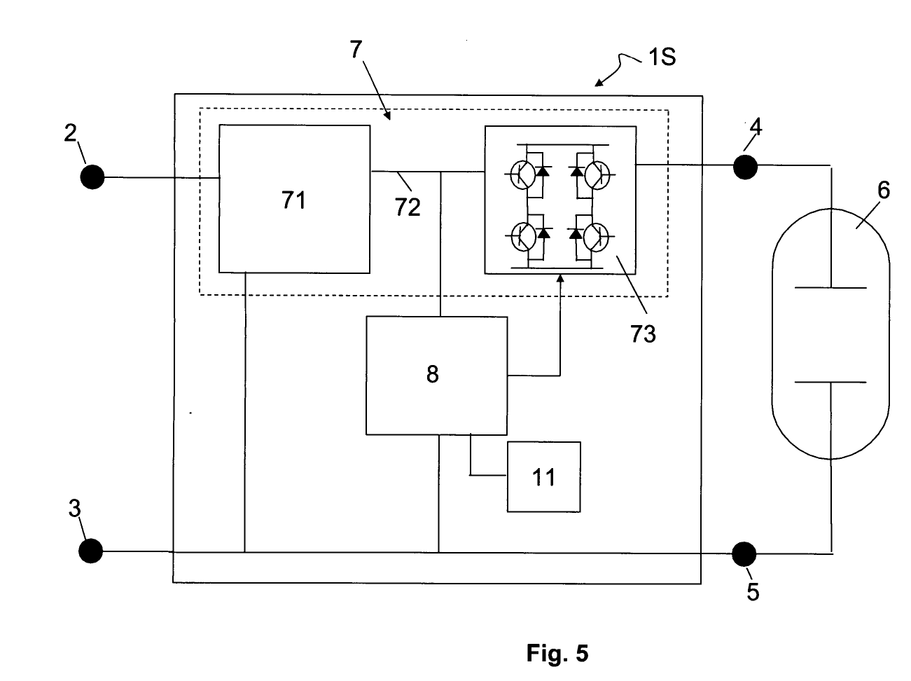

Notably, an exemplary embodiment of a “slave” type adjustment device is illustrated in FIG. 5. In one embodiment, slave adjustment devices 1S may be structurally simpler than the “master” type adjustment device, and preferably comprise one RF receiver 11 (although it may contain one or more additional receivers, for example, an RF, HF and/or UHF receiver) operationally connected to microcontroller 8 through a data bus, e.g. an IC² bus. Because in this exemplary embodiment, an RF receiver “replaces” a GPS receiver in slave adjustment device 1S, the slave adjustment device 1S may be less expensive to manufacture than the exemplary adjustment devices illustrated in FIGS. 1 to 3, all the other components being the same. However, a system according to the present invention may include one or more of any of the exemplary adjustment devices described and illustrated herein, including, for example, one or more adjustment devices of the embodiments of FIGS. 1-3.

Referring back to the system of FIG. 4, in one exemplary embodiment, “master” adjustment device 1M receives, processes and then re-sends or transmits the GPS signal (or a signal having data which (i) is representative of the GPS signal or (ii) includes information similar to or like that in the GPS signal), with a different frequency and possibly also in a different format, to slave adjustment devices 1S. The slave adjustment devices may receive the information provided by the “master” adjustment device 1M through receiver 11.

According to another embodiment, the slave adjustment devices may be fitted with an RF transceiver replacing a simple RF receiver 11, or alternatively they may comprise an RF transmitter in addition to RF receiver 11. Such an embodiment allows one or more slave adjustment devices 1S to re-send or transmit the current date and time information periodically.

Notably, implementing a system as described herein, allows the number of master devices 1M, which include a GPS receiver, to be reduced or minimized within a system. As such, the combined use of master and slave adjustment devices may provide a reduction in system costs because, though a master adjustment device may be more expensive than devices like those shown in FIG. 1 or 2, slave adjustment devices (for example, as illustrated in FIG. 5 and as discussed above) are likely less expensive than the adjustment devices of FIGS. 1-3.

The advantages of the present invention are apparent from the above description; in particular, there may be no need of using a clock/calendar module, since the GPS receiver receives date and time information constantly. Thus, in the event a (long) black-out should occur, the adjustment device according to the invention will receive the current date and time information necessary for the execution of the lamp luminous flux adjustment program as soon as power is restored.

Another advantage is offered by the fact that the broadcast signal (e.g. the GPS signal) employed is independent of the lighting system. In this way, there may be no need for broadcast system management or maintenance work.

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the above embodiments of the inventions are merely exemplary. They are not intended to be exhaustive or to limit the inventions to the precise forms, techniques, materials and/or configurations disclosed. Many modifications and variations are possible in light of this disclosure. It is to be understood that other embodiments may be utilized and operational changes may be made without departing from the scope of the present inventions. As such, the scope of the inventions are not limited solely to the description above because the description of the above embodiments has been presented for the purposes of illustration and description. Moreover, it is also clear that many changes may be made by those skilled in the art without departing from the teachings of the present invention as described and/or claimed.

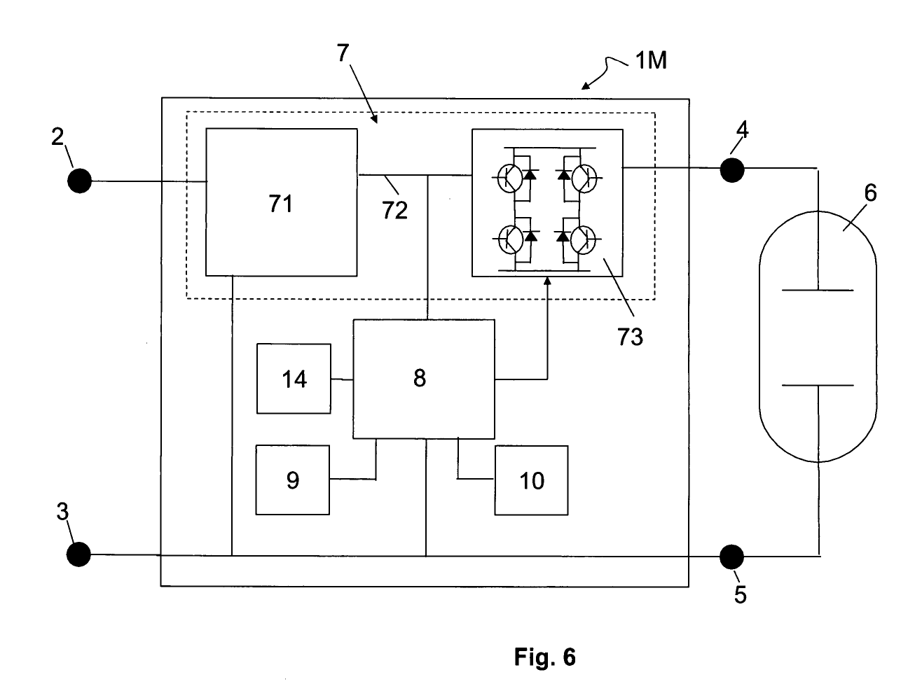

For example, the exemplary adjustment devices of FIGS. 1, 2, 3 and 5 may further comprise a clock/calendar module 14 which, as known, may include and/or essentially consist of a counter that is updated by a clock provided, for example, by microcontroller 8. In this case, microcontroller 8 obtains date and time information from the receiver (i.e. either GPS module 9 or RF receiver 11), which information is used for synchronizing the clock/calendar module. Such a configuration turns out to be advantageous whenever the broadcast signal carrying said date and time information is not transmitted constantly but, for example, once every hour. In this case, it may be advantageous that the adjustment device is fitted with an internal clock/calendar. By way of non-limiting example, a device of this kind is shown in FIG. 6, wherein a master device 1M fitted with a clock/calendar module 14 is operationally connected to microcontroller 8.

Notably, each of the aspects of the present invention, and/or embodiments thereof, may be employed alone or in combination with one or more of such aspects and/or embodiments. For the sake of brevity, all permutations and combinations will not be discussed separately herein. As such, the present inventions are neither limited to any single aspect (nor embodiment thereof), nor to any combinations and/or permutations of such aspects and/or embodiments.

Moreover, the above embodiments of the present inventions are merely exemplary embodiments. They are not intended to be exhaustive or to limit the inventions to the precise forms, techniques, materials and/or configurations disclosed. Many modifications and variations are possible in light of the above teaching. It is to be understood that other embodiments may be utilized and operational changes may be made without departing from the scope of the present inventions. As such, the foregoing description of the exemplary embodiments of the inventions has been presented for the purposes of illustration and description. Many modifications and variations are possible in light of the above teaching. It is intended that the scope of the inventions not be limited solely to the description above.

What is claimed is:

1. A device for adjusting the luminous flux of a lamp, comprising:
a conversion unit adapted to convert a main voltage into a supply voltage to be applied to the lamp; and
a microcontroller, coupled to the conversion unit, to control the conversion unit in accordance with a program of luminous flux adjustment wherein the program depends at least in part on a current date and a current time;
a receiver, coupled to the microcontroller, to receive a broadcast signal carrying information which is representative of a current date and a current time and to provide information which is representative thereof to the microcontroller.

2. The device of claim 1, wherein the conversion unit includes an AC/DC converter to convert an AC supply voltage to a DC voltage which is applied to the lamp.

3. The device of claim 1, further comprising a clock/calendar module to store a date and time information, wherein the microcontroller is coupled to the clock/calendar module in order to update the date and time in the clock/calendar module with information received through the broadcast signal.

4. The device of claim 3, wherein the microcontroller executes the program of luminous flux adjustment using the date and time information stored in the clock/calendar module.

5. The device of claim 4, wherein the broadcast signal includes a GPS signal.

6. The device of claim 4, further comprising a radio frequency transmitter to transmit a signal carrying current date and time information.

7. The device of claim 1, wherein the broadcast signal includes a GPS signal.

8. The device of claim 1, wherein the broadcast signal is a radio frequency signal.

9. The device of claim 1, further comprising a radio frequency transmitter to transmit a signal carrying current date and time information.

10. The device of claim 1, wherein the conversion unit includes an electronic ballast controlled by said microcontroller.

11. The device of claim 1, wherein the conversion unit includes a triac driven by a signal sent by the microcontroller for phase-cutting the main voltage.

12. A system for adjusting the luminous flux of a plurality of lamps, comprising:
a plurality of adjustment devices, wherein each adjustment device is coupled to an associated lamp to adjust the luminous flux of the associated lamp and includes:
a conversion unit adapted to convert a main voltage into a supply voltage to be applied to the lamp;
a microcontroller, coupled to the conversion unit, to control the conversion unit in accordance with a program of luminous flux adjustment wherein the program depends at least in part on a current date and time; and
a receiver, coupled to the microcontroller, to receive a broadcast signal carrying current date and time information and to provide information which is representative thereof to the microcontroller.

13. The system of claim 12, wherein at least one of the adjustment devices further includes a radio frequency transmitter and at least one of the adjustment devices further includes a radio frequency receiver adapted to receive a signal sent by said transmitter.

14. The system of claim 13, wherein a device adapted to receive the signal sent by the transmitter further includes a transmitter adapted to re-send the received signal.

15. The system of claim 12, wherein the receiver of at least one of the adjustment devices includes a GPS receiver and a radio frequency receiver.

16. A method for adjusting the flux of at least one lamp, the method comprising:
responsively adjusting and supplying a voltage to the at least one lamp in accordance with a luminous flux adjustment program which depends, at least in part, on a current date and time information; and
receiving the current date and time information through a broadcast signal.

17. The method of claim 16, further comprising:
storing the current date and time information in an adjustment device which is located in the vicinity of the lamp; and
updating the stored information using the information received through said broadcast signal.

18. The method of claim 16, further comprising:
re-sending the broadcast signal; and
receiving the re-sent signal in a second adjustment device which adjusts the luminous flux of a lamp associated with the second adjustment device.

19. The method of claim 18, wherein the broadcast signal and the re-sent signal have different frequencies.

20. The method of claim 16, wherein the broadcast signal is a GPS signal.
